(19) United States
(12) Patent Application Publication
(10) Pub. No.: US 2009/0158045 A1
(43) Pub. Date: Jun. 18, 2009

(54) LIGHT-OVERHEAD AND FLEXIBLE WIRELESS SENSOR MESSAGE AUTHENTICATION METHOD

(75) Inventors: Hung-Min Sun, Hsinchu (TW); Shih-Ying Chang, Hsinchu (TW)

Correspondence Address: STEIN MCEWEN, LLP, 1400 EYE STREET, NW, SUITE 300, WASHINGTON, DC, 20005, US

(73) Assignee: NATIONAL TSING HUA UNIVERSITY

(21) Appl. No.: 12/024,199

(22) Filed: Feb. 1, 2008

(30) Foreign Application Priority Data
Dec. 12, 2007 (TW) 096147340

(51) Int. Cl. H04L 9/00

(52) U.S. Cl. 713/181

(57) ABSTRACT

The present invention relates to a wireless sensor message authentication method, which is characterized by an authentication scheme of any message authentication code applied to any secure message authentication code (MAC); an authentication scheme using the concept of error correcting code (ECC) and applied to any binary ECC to provide different feature; flexible technique tuning required throughput and faulty data detection capability by adjusting the ECC in use; end-to-end authentication; and XOR operation conducted to original MAC to secure light overhead.

### FIELD OF THE INVENTION

The present invention relates to a wireless sensor message authentication method and more particularly to a message authentication method that applies error correcting code (ECC) technique to a bunch of message authentication codes generated by any algorithm to lower transmission throughput and maintain original characteristic of data authentication for message authentication code (MAC).

### BACKGROUND OF THE INVENTION

General data authentication means that content and source of data won't be changed. So far, the most prevailing technique is the message authentication code (MAC), such as HMAC-MD5, HMAC-SHA1 and so forth.

Please refer to FIG. 1, which is a schematic view showing a cluster-based wireless sensor network. In a cluster-based wireless sensor network, if a cluster is composed of k sensor nodes 11 and a cluster head 12, the cluster head 12 first receives data sent from the sensor nodes 11 thereof and further transmits the data to a base station 13. Normally, the cluster head 12 will employ the conventional methods, e.g. pairwise MAC (PMAC) or SXMAC, to process those data. Brief description is as follows and the corresponding scheme thereof is established herein.

(1) PMAC method—In this method, the cluster head 12 only transmits k pairs of messages and their corresponding MACs to the base station 13 without processing anything else. After receiving the k pairs of messages and their corresponding MACs, the base station 13 uses a MAC key to authenticate the MACs of the received messages and simultaneously complete the authentication of the k messages.
(2) SXMAC method—Prior to data transmission to the base station 13, the cluster head 12 first performs exclusive-OR operation on the k MACs to form a single exclusive-OR MAC (XORMAC) and transmit the XORMAC along with the messages pertinent to those k MACs to the base station 13. The base station 13 only authenticates the correctness of the XORMAC in completion of the authentication of the k messages.

On the one hand, as the SXMAC method only transmits an XORMAC, in contrast to the PMAC method requiring to transmit same number of MACs as messages, the communication overhead is lower. Therefore, the time or cost required for transmitting message is relatively and significantly less. On the other hand, the SXMAC method is prone to the Denial of Service (DoS) attack. When any received message incurs any change, the only thing we know from the authentication of the XORMAC is that there is an erroneous message while there's no way to tell which message is erroneous. Hence, once the authentication method of the XORMAC detects an error, all relates messages shall be discarded and retransmitted. In contrast, PMAC method can identify the erroneous message. All it needs is just to discard the erroneous message and ask the related sensor node 11 to retransmit, and other correct messages can still be used. However, the cost is that the MAC corresponding to each message should be transmitted. Power consumption of the cluster head 12 is the bottleneck whether the wireless sensor network can keep operating, especially when the cluster head 12 and the sensor nodes are the same type of equipment.

Accordingly, in view of the foregoing drawback of the prior art, the present invention combines both techniques of ECC and MAC to provide a light-overhead and flexible wireless sensor message authentication method, thereby improving the data authentication security of wireless sensor and maintaining original characteristic of MAC data authentication at the same time.

### SUMMARY OF THE INVENTION

In accordance with a main aspect of the present invention, a wireless sensor message authentication method is provides. The method includes steps of: (a) setting a syndrome vector generation count to be 1; (b) converting each message to be transmitted of k sensor nodes respectively into a MAC by a MAC scheme and transmitting the k messages and the k MACs to one of m cluster heads connected with the k sensor nodes, where k is a positive integer; (c) sequentially arranging the k messages to form a MAC vector multiplied by a generator matrix for performing an exclusive-OR operation in generation of a systematic code having less than k FXMACs and transmitting the FXMACs and the k messages to a base station; (d) using the MAC scheme to convert the k messages into k MACs and sequentially arranging the FXMACs and randomly arranging the MACs after the FXMACs to form a first received code vector multiplied by a transpose matrix of a parity-check matrix in generation of a first syndrome vector having at least a first sub-syndrome vector, setting the syndrome vector generation count equals to 2, and resuming executing step (b), if the syndrome vector generation count equals to 1; (e) otherwise, using the MAC scheme to convert the k messages into k MACs, sequentially arranging the FXMACs and then randomly arranging the k MACs after the FXMACs to form a second received code vector multiplied by the transpose vector of the parity-check matrix in generation of a second syndrome vector having at least one second sub-syndrome vector; (f) confirming that the k messages are all correct if the first syndrome vector and the second syndrome vector are all zero vector, otherwise performing each exclusive-OR operation among the first sub-syndrome vectors and among the second sub-syndrome vectors to obtain corresponding first exclusive-OR sub-syndrome vectors and second exclusive-OR sub-syndrome vectors; (g) comparing the first exclusive-OR sub-syndrome vectors and the second exclusive-OR sub-syndrome vectors, and determining that any identical one is a true sub-syndrome vector and any different one is a misjudged sub-syndrome vector; and (h) referring to a syndrome table according to each the true sub-syndrome vector to ascertain which one of the k MACs and corresponding the k messages are erroneous, and resuming executing step (a).

Preferably, the MAC scheme is selected from a group consisting of Md5-MAC, Shal-MAC, CMAC and AES-CMAC.

Preferably, a binary ECC scheme is selected from a group consisting of hamming code and extended hamming code.

Preferably, the number of said FXMACs is determined by the binary ECC scheme.

Preferably, the generator matrix is constituted by a parity-bit generator and an identity matrix in accordance with the binary ECC scheme.

Preferably, the parity-check matrix is constituted by an identity matrix and a transpose of the parity-bit generator in accordance with the binary ECC scheme.

Preferably, the first and the second sub-syndrome vectors are constituted by elements formed by sequentially extracting bit values of same binary bit fields in all elements of the first and second syndrome vectors respectively.

### BRIEF DESCRIPTION OF THE DRAWINGS

FIG. 1 is a schematic view showing a cluster-based wireless sensor network architecture; and

FIG. 2 is a schematic view showing message transmission and authentication in a cluster-based wireless sensor network in accordance with a preferred embodiment of the present invention;

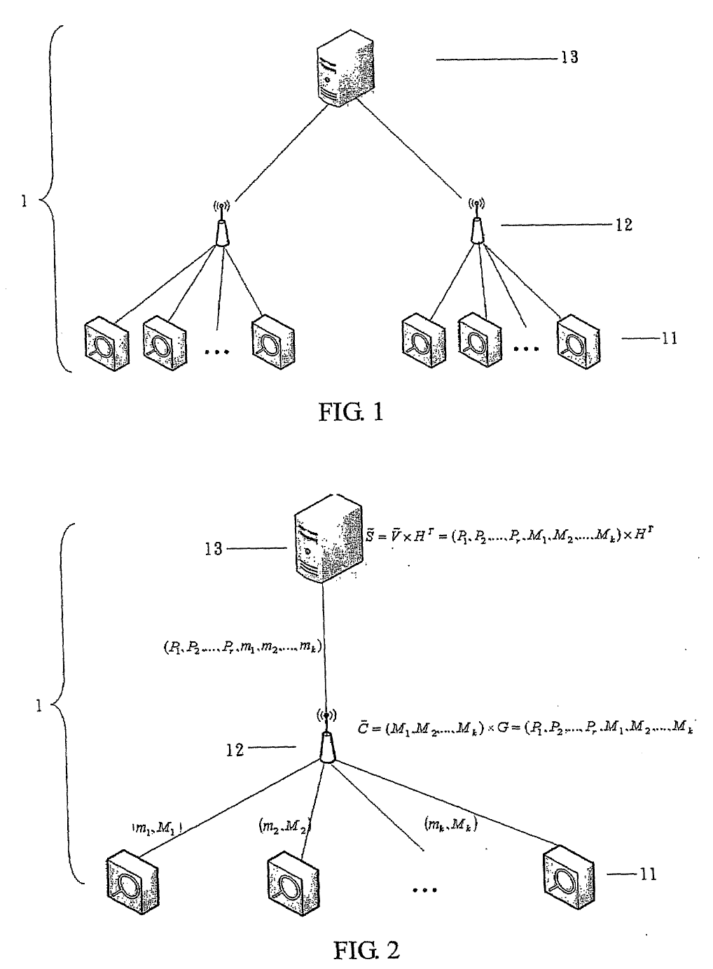

### DETAILED DESCRIPTION OF THE PREFERRED EMBODIMENT

To improve the high overhead of PMAC method and low addressing ability for erroneous data in SXMAC method, the present invention discloses a novel method requiring to transmit less flexible exclusive-OR message authentication codes (FXMAC), when messages are transmitted in a cluster-based wireless sensor network, so as to lower communication overhead and provide addressing ability for erroneous data at the same time. Neither the excessively large throughput as in the PMAC method nor the failure in detecting any single malicious node as in the SXMAC method will be caused by the method. The method can deliver different ability based on different ECC, and more importantly is that the security originally owned by MAC is still remained. The description of the present invention in the following is not exemplified to limit the present invention but to let people skilled in the related field fully comprehend.

The present invention targets at the prior arts of PMAC method and PXMAC method to bring a flexible message authentication method into existence and simultaneously combines ECC and MAC. The concept adopted by the present invention is depicted as follows:

Fundamental theory of the present invention lies in the use of linear binary code in ECC, and its concept is that an ECC is a set of codes in which each bit therein conform to a specific rule of construction so that each bit error can be detected and corrected. Assume that C is a linear (n, k) code, and two major transformation matrices are provided for linear systematic codes below.

The first one is a Generator Matrix which has the following form

G=[P_{k×(n-k)}|I_{k×k|]} (1)

where I_{k×k} is a k×k identity matrix, and p_{k×(n-k)} is a Parity-Bit Generator, the Generator Matrix G of the linear (n, k) code C is a k×n matrix whose each column forms a Basis of C. A message vector m=[m₁m₂ . . . mₖ] is multiplied by the Generator Matrix G to obtain the form of the following systematic code:

C^{ω}=mG=[p₁p₂ . . . p₍ₙ₋ₖ₎m₁m₂ . . . mₖ] (2)

where pᵢ is a parity bit and mᵢ is an original message bit.
The other transformation matrix is a Parity-Check Matrix which has the following form

H=[I_{(n-k)×(n-k)}|P^{T}] (3)

where I_{(n-k)×(n-k)} is a (n-k)×(n-k) identity matrix, and P^{T} is a transpose matrix of the Parity Bit Generator.
Next, the following equation is used to calculate a Syndrome s^{ω} to verify the received code [symbol] ^{ω}

s^{ω}= [symbol] ^{ω}H^{T}=(c^{ω}+e^{ω})H^{T}=e^{ω}H^{T} (4)

where e^{ω} is an error vector. If there is no error, e^{ω} and s^{ω} are all zero vectors. According to the value of S^{ω}, an erroneous bit in the υ^{ω} can be located.

Based on the above-mentioned fundamental theory, the major change of the technique in the present invention is to replace the mᵢ in the original message code m, which is a bit, with a MAC of a node. Please refer to FIG. 2, which is a schematic view showing the message transmission and authentication in a cluster-based wireless sensor network in accordance with a preferred embodiment of the present invention. The message authentication method of the present invention is applicable to a cluster-based wireless sensor network, which is composed of a base station 13, m (one is shown only) clusters 12 connected with the base station 13, and k sensor nodes 11 each connected with k sensor nodes 11, for maintaining an end-to-end authentication.

The message authentication method includes steps of:

(a) setting a syndrome vector generation count to be 1;
(b) converting each message to be transmitted of k sensor nodes 11 respectively into a MAC by a MAC scheme and transmitting the k messages and the k MACs to one of m cluster heads 12 connected with the k sensor nodes 11, in which k is a positive integer, the MAC scheme can be any one of Md5-MAC, Shal-MAC, CMAC and AES-CMAC;
(c) sequentially arranging the k messages to form a MAC vector multiplied by a generator matrix for performing an exclusive-OR operation in generation of a systematic code having less than k FXMACs and transmitting the FXMACs and the k messages to a base station, in which the generator matrix is defined by a binary ECC scheme, such as the Hamming Code or Extended Hamming Code, and the number of the FXMAC, i.e. k in this case, is determined by the adopted binary ECC scheme;
(d) using the MAC scheme to convert the k messages into k MACs and sequentially arranging the FXMACs and randomly arranging the MACs after the FXMACs to form a first received code vector multiplied by a transpose matrix of a parity-check matrix in generation of a first syndrome vector having at least a first sub-syndrome vector, setting the syndrome vector generation count equals to 2, and resuming executing step (b), if the syndrome vector generation count equals to 1;
(e) otherwise, using the MAC scheme to convert the k messages into k MACs, sequentially arranging the FXMACs and then randomly arranging the k MACs after the FXMACs to form a second received code vector multiplied by the transpose vector of the parity-check matrix in generation of a second syndrome vector having at least one second sub-syndrome vector;
(f) confirming that the k messages are all correct if the first syndrome vector and the second syndrome vector are all zero vector, otherwise performing each exclusive-OR operation among the first sub-syndrome vectors and among the second sub-syndrome vectors to obtain corresponding first exclusive-OR sub-syndrome vectors and second exclusive-OR sub-syndrome vectors;
(g) comparing the first exclusive-OR sub-syndrome vectors and the second exclusive-OR sub-syndrome vectors, and determining that any identical one is a true sub-syndrome vector and any different one is a misjudged sub-syndrome vector; and
(h) referring to a syndrome table according to each true sub-syndrome vector to determine which one of the k MACs and the corresponding k messages are erroneous, and resuming executing step (a).

To make the flexible message authentication method more comprehensive, here is an example for explanation:

If the Hamming code (7, 4) is chosen as the binary ECC scheme, the defined Generator Matrix G and the Parity-Check Matrix H are as follows:

$$G = [ \begin{matrix}1 & 1 & 0 & 1 & 0 & 0 & 0 \\ 1 & 0 & 1 & 0 & 1 & 0 & 0 \\ 0 & 1 & 1 & 0 & 0 & 1 & 0 \\ 1 & 1 & 1 & 0 & 0 & 0 & 1\end{matrix} ]$$

$$H = [ \begin{matrix}1 & 0 & 0 & 1 & 1 & 0 & 1 \\ 0 & 1 & 0 & 1 & 0 & 1 & 1 \\ 0 & 0 & 1 & 0 & 1 & 1 & 1\end{matrix} ]$$

Besides, the following Table 1, which is a Syndrome Table for Hamming code (7, 4), also provides syndrome vectors and error vectors in association with the Hamming code (7, 4).

TABLE 1
Syndrome table for Hamming Code

| ē | s̅ |
|---|---|
| (1, 0, 0, 0, 0, 0, 0) | (1, 0, 0) |
| (0, 1, 0, 0, 0, 0, 0) | (0, 1, 0) |
| (0, 0, 1, 0, 0, 0, 0) | (0, 0, 1) |
| (0, 0, 0, 1, 0, 0, 0) | (1, 1, 0) |
| (0, 0, 0, 0, 1, 0, 0) | (1, 0, 1) |
| (0, 0, 0, 0, 0, 1, 0) | (0, 1, 1) |
| (0, 0, 0, 0, 0, 0, 1) | (1, 1, 1) |
| (0, 0, 0, 0, 0, 0, 0) | (0, 0, 0) |

A message vector m^{ω} is converted into a MAC vector M^{ω}, and the MAC vector M^{ω} is multiplied by a generator matrix G to convert into a systematic code C^{ω} was shown in the following equation:

$$\begin{matrix}{C}^{ω} = ( {C}_{1} , {C}_{2} … , {C}_{7} ) = {M}^{ω} \times G \\ = ( {M}_{1} , {M}_{2} , … , {M}_{4} ) \times [ \begin{matrix}1 & 1 & 0 & 1 & 0 & 0 & 0 \\ 1 & 0 & 1 & 0 & 1 & 0 & 0 \\ 0 & 1 & 1 & 0 & 0 & 1 & 0 \\ 1 & 1 & 1 & 0 & 0 & 0 & 1\end{matrix} ] \\ = ( {P}_{1} , {P}_{2} , {P}_{3} , {M}_{1} , {M}_{2} , … , {M}_{4} ) \\ = ( {M}_{1} ⊕ {M}_{2} ⊕ {M}_{4} , {M}_{1} ⊕ {M}_{3} ⊕ {M}_{4} , {M}_{2} ⊕ {M}_{3} ⊕ {M}_{4} , \\ {M}_{1} , {M}_{2} , {M}_{3} , {M}_{4} )\end{matrix} \qquad \begin{matrix} \\ \\ \\ \\ \\ ( 5. a ) \\ ( 5. b )\end{matrix}$$

where pᵢ is the FXMAC of the present invention, and each FXMAC has the same length of MAC.

When a MAC vector M equals to (00, 01, 01, 11), and is substituted in Eqn (5.b), the systematic code C=(10, 10, 11, 00, 01, 01, 11) is obtained. From Eqn (5.a), a cluster 12 only needs to transmit three FXMACs to the base station 13, requiring to transmit less than four MACs in PMAC method to the base station 13. Despite not having a significant difference in this case, if the Hamming code (15, 11) is taken into account, the PMAC method needs to transmit 11 MACs; however, the present invention only needs to transmit 4 FXMACs to the base station 13, thereby obviously telling that the method of the present invention greatly reduces the communication overhead upon transmitting MACs.

When the cluster head 12 transmits the FXMACs and message bits (p₁, p₂, p₃, m₁, m₂, m₃, m₄) to a base station 13, the base station 13 first convert message bits (m₁, m₂, m₃, m₄) into MACs (M₁, M₂, M₃, M₄). If the received code V^{ω} is (10, 10, 11, 00, 01, 01, 11), it is substituted in Eqn (4) and a syndrome vector S^{ω} (10, 10, 00) is obtained. As it is a non-zero vector, the messages transmitted to the base station 13 are thus confirmed to contain error. Moreover, the syndrome vector S^{ω} can be expressed as follows

S^{ω}=(s₁¹s₁² . . . s₁¹, s₂¹s₂² . . . s₂¹, . . . , sᵣ¹sᵣ² . . . sᵣ¹), (6)

where s^{ω}^{₁}=(sᵣⁱsᵣⁱ . . . sᵣⁱ) and s^{ω}^{₁} is the sub-syndrome vector of the i-th block. According to Eqn (6), S^{ω}(10, 10, 00) is composed of the sub-syndrome vectors of two different blocks, which are s^{ω}^{₁}=(1, 1, 0) and s^{ω}^{₂}=(0, 0, 0) respectively. After referring to Table 2 for s^{ω}^{₁}, the corresponding error vector is (0, 0, 0, 1, 0, 0, 0), which represents that the fourth bit in the first block is an erroneous bit or that the first bit in V₄ is an erroneous bit.

A traditional ECC method has only one syndrome vector. Unlike traditional ECC method, the flexible message authentication method could detect errors of multiple messages. Whereas, when the number of erroneous message is too many, the addressing ability for erroneous data will be significantly lowered. This phenomenon could be explained by the example given below.

Given the Hamming Code (7, 4) as an example, if the first message is erroneous, the e^{ω} in Eqn (4) is (0, 0, 0, 1, 0, 0, 0); if the second message is erroneous, the e^{ω} is (0, 0, 0, 0, 1, 0, 0); when the first message and the second message are both erroneous, the e^{ω} is (0, 0, 0, 1, 1, 0, 0). After the mentioned e^{ω} are substituted into Eqn (4), the sub-syndrome vector S^{ω} is (1, 1, 0) when the first message is erroneous, (1, 0, 1) when the second message is erroneous, and (0, 1, 1) (equivalent to the result of (1, 1, 0) XOR (1, 0, 1)) when the first message and the second message are erroneous at the same time. Consequently, when the traditional Hamming Code scheme is used to determine a condition of multiple errors, not only do the erroneous conditions of the first message and the second message (i.e. so-called undetectable error) fail to be detected, but also the sub-syndrome vector (0, 1, 1) becomes a misjudged error because it is not an error that actually happens.

In comparison with a traditional ECC method, the flexible message authentication method could generate sub-syndrome vectors whose count equals to the length of MAC. Similarly, there is very high chance that the flexible message authentication method will obtain the sub-syndromes (1, 1, 0), (1, 0, 1), (0, 1, 1) and the like and treat the messages represented thereby as erroneous message. Therefore, although the flexible message authentication method could prevent the undetectable error in the traditional ECC method, (0, 1, 1) will still be treated to be erroneous and the misjudged error still takes place. Meanwhile, in view of increasing erroneous messages, the XOR operations occurring among all sub-syndrome vectors of the flexible message authentication method also increase, and inevitably, many of them are misjudged errors instead of actual errors.

To cope with such misjudged error, the present invention converts the messages received from the base station into MACs and sequentially arranges the received FXMACs and the MACs in the expression of Eqn (5 a), in which the portion that actually changes is the portion of MAC only, with two different orders. Speaking of the example for Hamming Code (7, 4), the first order in coding and arranging the FXMACs and the MACs remains intact, which is expressed as follows:

[p₁p₂p₃m₁m₂m₃m₄]

The second order in coding and arranging the FXMACs and the MACs employs the following sequence, for instance,

[p₁p₂p₃m₁m₄m₃m₂]

The above expression is indeed the [symbol] ^{ω} in Eqn (4), and the MACs in the expression arranged in the second order are coded in a random manner. The expression, i.e. [symbol] ^{ω}, is multiplied by the transpose matrix of the parity-check matrix (H^{T}) to obtain a syndrome vector, and the corresponding sub-syndrome vector of each block is decomposed in accordance with Eqn (6). While comparing the sub-syndrome vectors obtained through the expression arranged in two different code arrangements, repeated sub-syndrome vector stands for a true message error, and other different sub-syndrome vectors stands for possibly misjudged message errors.

If the blocks selected for the comparison of syndrome vector are not enough, the obtained sub-syndrome vectors will be insufficient. As a result, the sub-syndrome vectors obtained by the two coding arrangements won't be able to reflect all the misjudged errors. Assume that the total number of the resulting sub-syndrome vectors is k, and XOR operations are performed among all sub-syndrome vectors obtained one another (every two, every three, . . . every k sub-syndromes) to obtain different sub-syndrome vectors. The sub-syndrome vectors obtained respectively through the two different coding arrangements are further compared mutually, and those which are identical are true errors while those which are different may be very likely misjudged errors.

The aforementioned method using XOR operation to reduce misjudged error is based on a theory as follows:

If a set A represents sub-syndrome vectors of actual erroneous data, a set B represents all the sub-syndrome vectors obtained in the verification process, and B=span (A), that is the set B is spun out of the set A, the span function performs a linear combination of the sub-syndrome vectors of the set A and is used for addition of modulus 2 which is equivalent to the result of XOR operation of those combinations. In addition, let a subset of the set B be C, the result of span (C) is definitely contained in B mostly because the elements of the set B come from the combination of elements in the set A. Meanwhile, what span (C) is definitely included in B means that if a subset of set B (i.e. set C) is obtained instead of all the sub-syndrome vectors in the verification process (i.e. set B), other unavailable sub-syndrome vectors may be obtained and misjudged error will not occur by the result of span (C) because the result will be contained in the set B only. Given the method with such XOR operation, the error-detecting ability could be improved.

Regarding the method using XOR operation to reduce misjudged error, an example is given below for more detailed description.

Given the Hamming code (7, 4) as the example, if there are actually three errors, the sub-syndrome vectors generated by the first coding arrangement are (1, 1, 0), (1, 0, 1) and (0, 1, 1), in which the results of XOR operation for any two or three sub-syndromes are identical to the three sub-syndrome vectors; the sub-syndrome vectors generated by the second coding arrangement are (1, 1, 0), (1, 0, 1) and (1, 1, 1), in which the results of XOR operation for any two or three sub-syndromes are (0, 0, 1), (0, 1, 0), (1, 0, 0), (0, 1, 1), (1, 1, 0), (1, 0, 1) and (1, 1, 1). By comparing the sub-syndrome vectors generated in the two coding arrangements, the actual erroneous sub-syndrome vectors are (1, 1, 0), (1, 0, 1) and (1, 1, 1), and (0, 0, 1), (0, 1, 0), (1, 0, 0) and (1, 1, 1) are very likely the misjudged errors instead of the true errors.

Table 2 is a comparison between the present invention and the PMAC method or the SXMAC method with an emphasis on communication overhead and addressing ability for erroneous data, in which the addressing ability for erroneous data means the ability to determine from which sensor node 11 erroneous data come.

TABLE 2

| | | | The present |
|---|---|---|---|
| | PMAC | SXMAC | invention |
| Communication | High | Low | Medium |
| overhead | | | |
| Addressing ability | High | Low | Medium |
| for erroneous data | | | |

From Table 2, the implementation of the present invention not only improves the issue of excessively large throughput for the PMAC method but also overcomes the issue of the SXMAC method that malicious node fails to be detected. To reduce error misjudgment, more blocks could be cut and different coding sequences could be adopted while designing. All it costs is just the memory space for storing those coding sequences and some additional computations, making such investment worthy.

In sum, in contrast to prior art, the present invention provides a method that transmits less FXMACs to reduce communication overhead, provides addressing ability for erroneous data, and flexibly applies different ECC scheme to tailor for different requirement while maintaining original security of MAC. From the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A wireless sensor message authentication method, comprising steps of:
(a) setting a syndrome vector generation count to be 1;
(b) converting each message to be transmitted of k sensor nodes respectively into a MAC by a MAC scheme and transmitting said k messages and said k MACs to one of m cluster heads connected with said k sensor nodes, where k is a positive integer;
(c) sequentially arranging said k messages to form a MAC vector multiplied by a generator matrix for performing an exclusive-OR operation in generation of a systematic code having less than k FXMACs and transmitting said FXMACs and said k messages to a base station;
(d) using said MAC scheme to convert said k messages into k MACs and sequentially arranging said FXMACs and randomly arranging said MACs after said FXMACs to form a first received code vector multiplied by a transpose matrix of a parity-check matrix in generation of a first syndrome vector having at least a first sub-syndrome vector, setting said syndrome vector generation count equals to 2, and resuming executing step (b), if said syndrome vector generation count equals to 1;
(e) otherwise, using said MAC scheme to convert said k messages into k MACs, sequentially arranging said FXMACs and then randomly arranging said k MACs after said FXMACs to form a second received code vector multiplied by said transpose vector of said parity-check matrix in generation of a second syndrome vector having at least one second sub-syndrome vector;
(f) confirming that said k messages are all correct if said first syndrome vector and said second syndrome vector are all zero vector, otherwise performing each exclusive-OR operation among said first sub-syndrome vectors and among said second sub-syndrome vectors to obtain corresponding first exclusive-OR sub-syndrome vectors and second exclusive-OR sub-syndrome vectors;
(g) comparing said first exclusive-OR sub-syndrome vectors and said second exclusive-OR sub-syndrome vectors, and determining that any identical one is a true sub-syndrome vector and any different one is a misjudged sub-syndrome vector; and
(h) referring to a syndrome table according to each said true sub-syndrome vector to ascertain which one of said k MACs and corresponding said k messages are erroneous, and resuming executing step (a).

2. The wireless sensor message authentication method as claimed in claim 1, wherein said MAC scheme is selected from a group consisting of Md5-MAC, Shal-MAC, CMAC and AES-CMAC.

3. The wireless sensor message authentication method as claimed in claim 1, wherein said generator matrix is defined by a binary ECC scheme selected from a group consisting of hamming code and extended hamming code.

4. The wireless sensor message authentication method as claimed in claim 1, wherein the number of said FXMACs is determined by a binary ECC scheme.

5. The wireless sensor message authentication method as claimed in claim 1, wherein said generator matrix is constituted by a parity-bit generator and an identity matrix in accordance with a binary ECC scheme.

6. The wireless sensor message authentication method as claimed in claim 1, wherein said parity-check matrix is constituted by an identity matrix and a transpose of said parity-bit generator in accordance with a binary ECC scheme.

7. The wireless sensor message authentication method as claimed in claim 1, wherein said first and said second sub-syndrome vectors are constituted by elements formed by sequentially extracting bit values of same binary bit fields in all elements of said first and second syndrome vectors respectively.
